(19) United States
(12) Patent Application Publication
(10) Pub. No.: US 2018/0101838 A1
(43) Pub. Date: Apr. 12, 2018

(54) Method and System for Facilitating Mobile Payment for Products

(71) Applicant: MASTERCARD ASIA/PACIFIC PTE. LTD., Singapore (SG)

(72) Inventors: Teck Yong Tan, Singapore (SG); Yong How Chin, Singapore (SG); Noor Ali Nizar Ali, Singapore (SG); Xijing Wang, Singapore (SG); Tobias Puehse, Singapore (SG)

(21) Appl. No.: 15/726,876

(22) Filed: Oct. 6, 2017

(30) Foreign Application Priority Data
Oct. 7, 2016 (SG) 10201608427Q

(51) Int. Cl. G06Q 20/32; G06Q 20/42; G06Q 20/36

(52) U.S. Cl. CPC G06Q 20/3278; G06Q 20/36; G06Q 20/42

(57) ABSTRACT

A method and system for facilitating mobile payment for products includes: receiving a first container identifier encoded on a first container tag attached to a physical container for holding the products; receiving a wallet identifier corresponding to a digital wallet installed on a mobile device; linking a virtual container associated with the first container identifier to the digital wallet through the wallet identifier; receiving, from a checkout device, (i) a product identifier encoded on a product tag attached to each of the products held in the physical container and (ii) a second container identifier encoded on a second container tag attached to the physical container; and, when the first and the second container identifiers are identical, populating the virtual container with virtual products corresponding to each of the product identifiers received from the checkout device such that the mobile payment of the products can be made using the digital wallet.

### CROSS-REFERENCE TO RELATED APPLICATION

This application claims the benefit of and priority to Singapore Patent Application No. 10201608427Q filed Oct. 7, 2016. The entire disclosure of the above application is incorporated herein by reference.

### FIELD

The present disclosure relates broadly, but not exclusively, to methods and systems for facilitating mobile payment for products.

### BACKGROUND

This section provides background information related to the present disclosure which is not necessarily prior art.

Mobile payment generally refers to payment services operated under financial regulation and performed from or via a mobile computing device, such as a smartphone or tablet computer. Instead of paying with cash, cheque, or payment cards (e.g., credit cards, debit cards, etc.), a consumer can use a mobile device to pay for services, digital goods or hard goods. Currently, mobile payment at retail stores is not frictionless because a customer's information (e.g., digital wallet details) is required so that details of items to be purchased (typically, at least the total cost of such items) can be pushed to a mobile wallet application installed on the customer's mobile device before payment can be made.

Instead of traditional cashier-staffed checkouts, some merchants allow customers to perform “self-checkout”. Customers assume the role of the cashier by inputting details of their purchase (e.g., by scanning the bar code printed on or attached to each of the products they wish to purchase) and applying for payment themselves (e.g., swiping their payment card at the merchant's point-of-sale terminal). However, this “self-checkout” procedure is prone to delays as many customers are not familiar with the procedure, especially the payment aspect.

A need therefore exists to provide methods and system for facilitating mobile payment for products that seek to address at least some of the above problems.

### SUMMARY

This section provides a general summary of the disclosure, and is not a comprehensive disclosure of its full scope or all of its features. Aspects and embodiments of the disclosure are set out in the accompanying claims.

According to a first aspect, there is provided a method for facilitating mobile payment for products, comprising: receiving, from a mobile device, a first container identifier encoded on a first container tag attached to a physical container for holding the products; receiving, from the mobile device, a wallet identifier corresponding to a digital wallet installed on the mobile device; linking, using a server module in communication with the mobile device, a virtual container associated with the received first container identifier to the digital wallet through the received wallet identifier; receiving, from a checkout device in communication with the server module, (i) a product identifier encoded on a product tag attached to each of the products held in the physical container and (ii) a second container identifier encoded on a second container tag attached to the physical container; and, on a condition that the first and the second container identifiers are identical, populating, using the server module, the virtual container with virtual products corresponding to each of the product identifiers received from the checkout device such that the mobile payment of the products can be made using the digital wallet that is linked to the virtual container.

The method may further comprise: generating, using the server module, a payment approval request after populating the virtual container with the virtual products; and transmitting the payment approval request from the server module to the mobile device.

The method may further comprise: receiving, from the mobile device, a payment approval grant that is generated by the mobile device in response to approval of the mobile payment, wherein the mobile payment of the products can be completed upon receipt of the payment approval grant.

The method may further comprise: receiving, from the mobile device, credentials stored in the digital wallet, the credentials comprising consumer product purchase preferences; generating, using the server module, personalization data based on the received credentials, the personalization data relating to the consumer product purchase preferences; and transmitting the personalization data to a broadcast module in communication with the server module, the broadcast module configured to provide product purchase information based on the personalization data.

The method may further comprise: generating, using the server module, a link success notification after linking the virtual container to the digital wallet; and transmitting the link success notification from the server module to the mobile device.

The first container tag may comprise: a near field communication (NFC) tag; a bar-code; a Quick Response (QR) Code; or a Bluetooth® Low Energy (BLE) tag. The second container tag and/or the product tag may comprise a radio frequency identification (RFID) tag.

The method may further comprise: providing, using the server module, the virtual container associated with the first container identifier upon receipt of the first container identifier from the mobile device.

The method may further comprise: enrolling, in a database in communication with the server module, the product identifiers in association with their respective product data, wherein the product data of each product comprises a price and a description of the product. After the step of populating the virtual container with virtual products corresponding to each of the product identifiers received from the checkout device, the method may further comprise: retrieving, from the database, the respective product data of each virtual product in the virtual container; and updating the digital wallet with the respective product data of each virtual product in the virtual container retrieved from the database.

According to a second aspect, there is provided a system for facilitating mobile payment for products, comprising: a server module in communication with a mobile device and a checkout device, wherein the server module is configured to: receive, from the mobile device, a first container identifier encoded on a first container tag attached to a physical container for holding the products; receiving, from the mobile device, a wallet identifier corresponding to a digital wallet installed on the mobile device; linking a virtual container associated with the received first container identifier to the digital wallet through the received wallet identifier; receiving, from the checkout device: (i) a product identifier encoded on a product tag attached to each of the products held in the physical container and (ii) a second container identifier encoded on a second container tag attached to the physical container; and, on a condition that the first and the second container identifiers are identical, populate the virtual container with virtual products corresponding to each of the product identifiers received from the checkout device such that the mobile payment of the products can be made using the digital wallet that is linked to the virtual container.

The server module may be further configured to: generate a payment approval request after populating the virtual container with the virtual products; transmit the payment approval request to the mobile device; and receive, from the mobile device, a payment approval grant that is generated by the mobile device in response to approval of the mobile payment, wherein the mobile payment of the products can be completed upon receipt of the payment approval grant.

The server module may be further configured to: receive, from the mobile device, credentials stored in the digital wallet, the credentials comprising consumer product purchase preferences; generate personalization data based on the received credentials, the personalization data relating to the consumer product purchase preferences; and transmit the personalization data to a broadcast module in communication with the server module, the broadcast module configured to provide product purchase information based on the personalization data.

The server module may be further configured to: generate a link success notification after linking the virtual container to the digital wallet; and transmit the link success notification to the mobile device.

The server module may be further configured to provide the virtual container associated with the first container identifier upon receipt of the first container identifier from the mobile device.

The system may further comprise a database in communication with the server module, wherein the product identifiers in association with their respective product data are enrolled in the database, and wherein the product data of each product comprises a price and a description of the product.

After populating the virtual container with virtual products corresponding to each of the product identifiers received from the checkout device, the server module may be further configured to: retrieve, from the database, the respective product data of each virtual product in the virtual container; and update the digital wallet with the respective product data of each virtual product in the virtual container retrieved from the database.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. Embodiments will be better understood and readily apparent to one of ordinary skill in the art from the following written description, by way of example only, and in conjunction with the drawings, in which:

FIG. 1 shows a flow chart illustrating a method for facilitating mobile payment for products, according to an example embodiment;

FIG. 2 shows a physical container for holding products, according to an example embodiment;

FIG. 3 shows a checkout device, according to an example embodiment;

FIG. 4 shows a schematic diagram of a system for facilitating mobile payment for products, according to an example embodiment; and

FIG. 5 shows a schematic diagram of a computer system suitable for use in executing the method for facilitating mobile payment for products.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure. Again, like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer suitable for executing the various methods/processes described herein will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices, such as magnetic or optical disks, memory chips, or other storage devices suitable for interfacing with a computer. The computer readable medium may also include a hard-wired medium, such as exemplified in the Internet system, or wireless medium, such as exemplified in the GSM mobile telephone system. The computer program when loaded and executed on such a computer effectively results in an apparatus that implements the steps of the preferred method.

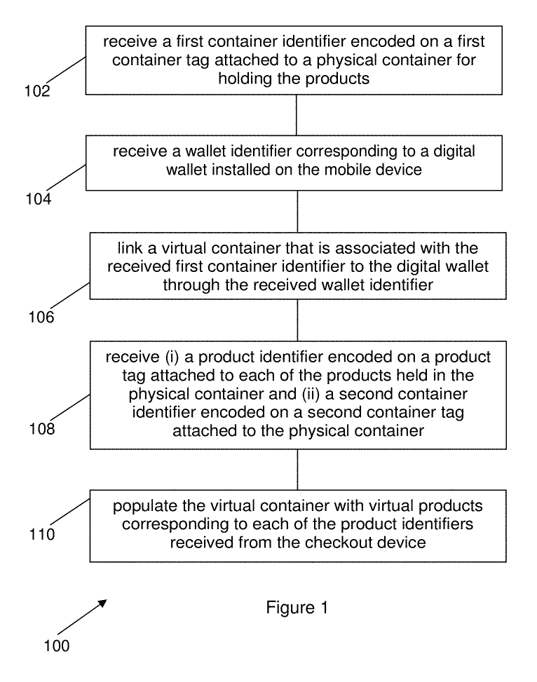

FIG. 1 shows a flow chart illustrating a method 100 for facilitating mobile payment for products, according to an example embodiment.

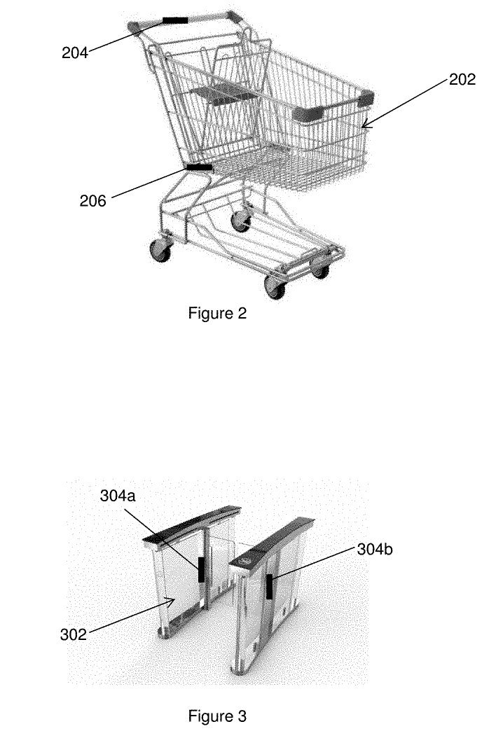

Step 102 of the mobile payment facilitation method 100 involves receiving, from a mobile device, a first container identifier encoded on a first container tag attached to a physical container for holding the products. The first container tag may include one or more of a near field communication (NFC) tag, a bar-code, a Quick Response (QR) Code, or a Bluetooth® Low Energy (BLE) tag. The physical container may be a supermarket trolley or a supermarket basket. In the current context, a container tag that is attached to a physical container includes a tag that is printed on the container, integral with or embedded into the container, or secured by any suitable means onto the container. With reference to FIG. 2, the first container tag 204 may be attached to a handle portion of the supermarket trolley 202.

Step 104 of the method 100 involves receiving, from the mobile device, a wallet identifier corresponding to a digital wallet that is installed on the mobile device. The digital wallet allows a consumer to participate in electronic commerce transactions and has both a software and information component where the software provides security and encryption for the consumer's personal information and for the electronic commerce transaction. Each digital wallet has a unique wallet identifier and is used to identify a specific digital wallet.

The mobile device (e.g., a smartphone or tablet computer) is used to retrieve the first container identifier encoded on the first container tag attached to the physical container. The mobile device comprises a reader module suitable for retrieving the first container identifier encoded on the first container tag (e.g., a near field communication (NFC) reader, a bar-code reader, a Quick Response (QR) Code reader, or a Bluetooth® Low Energy (BLE) receiver module). The first container identifier is a unique identifier that is used to identify the specific container. The mobile device is also used to transmit the retrieved first container identifier (from step 102) and the wallet identifier to a server module that is in communication with the mobile device.

Step 106 of the method 100 involves using the server module to link or bind a virtual container associated with the received first container identifier (at step 102) to the digital wallet through the received wallet identifier (at step 104). Upon receipt of the first container identifier from the mobile device (at step 102), the server module may generate, create or provide the virtual container associated with the first container identifier. The virtual container acts as a proxy for the actual physical container in order to facilitate mobile payment using the digital wallet. The virtual container may be provided to the digital wallet to facilitate mobile payment, as will be explained in more detail below. The virtual container may be seen as a repository of products that a consumer wishes to purchase. After linking the virtual container to the digital wallet, the server module may generate a link success notification and transmit this link success notification to the mobile device so that the consumer is notified that his digital wallet has been successfully linked to the virtual container.

Steps 102, 104 and 106 may take place before a consumer begins shopping at a merchant's premises. These three steps can be considered as part of a session initiation phase of a mobile payment process. After step 106 has taken place, the consumer may now proceed to place products that he wishes to purchase into the physical container. For example, during grocery shopping at a supermarket, the consumer can place products that he wishes to purchase into the supermarket trolley or basket. Once the consumer has finished shopping, he proceeds to checkout at a checkout device that is located at the merchant's premises. The checkout device is in communication with the server module.

Step 108 of the method 100 involves receiving, from the checkout device: (i) a product identifier encoded on a product tag attached to each of the products held in the physical container, and (ii) a second container identifier encoded on a second container tag attached to the physical container. In the current context, a product tag that is attached to a product includes a product tag that is printed on the container, integral with or embedded into the container, or secured by any suitable means onto the product itself or a packaging of the product.

In an implementation, the second container tag and/or the product tag may comprise a radio frequency identification (RFID) tag. The checkout device may comprise a RFID scanner or reader for reading the RFID tags.

Referring back to FIG. 2, the second container identifier is encoded on the second container tag 206 attached to the supermarket trolley 202.

For example, the consumer wishes to purchase a box of cereal and a bottle of water and these two items are placed in the container (e.g., supermarket trolley). The box of cereal and bottle of water each have a RFID product tag attached thereon. The consumer pushes the supermarket trolley through the checkout device 302 which is configured as a gantry and has a plurality of RFID scanners 304a/304b as shown in FIG. 3.

The checkout device retrieves the product identifier encoded on the product tag attached to each of the products (e.g., the product identifier of the box of cereal and the product identifier of the bottle of water) and the second container identifier encoded on the second container tag. The retrieved product identifiers and the second container identifier are then transmitted to the server module.

A check is performed to determine whether the first container identifier (received at step 102) is identical to the second container identifier (received at step 108). If the first and the second container identifiers are identical, this implies that the physical container which is being presented at the checkout device is the same physical container that was used to provide a link between its corresponding virtual container and the consumer's digital wallet.

On a condition that the first and the second container identifiers are identical, step 110 of the method 100 is performed, which involves using the server module to populate the virtual container with virtual products corresponding to each of the product identifiers received from the checkout device such that the mobile payment of the products can be made using the digital wallet that is linked to the virtual container. Similar to the virtual container, the virtual product is a proxy for the actual product and may be seen as an entry in the repository (i.e. the virtual container). On the other hand, if the first and the second container identifiers do not match, the method for mobile payment is aborted.

It will be appreciated that some of the steps described above are not necessarily performed sequentially—e.g., step 104 can be performed before 102, or steps 102 and 104 can be performed in parallel.

In an implementation, the method 100 may further include enrolling, in a database that is in communication with the server module, the product identifiers in association with their respective product data. The product data of each product comprises, but is not limited to, a price and/or a description of the product.

After populating the virtual container with the virtual products corresponding to each of the product identifiers received from the checkout device (at step 110 above), the respective product data of each virtual product in the virtual container may be retrieved from the database. The digital wallet may be updated with the respective product data of each virtual product in the virtual container retrieved from the database. In this case, a user interface of the digital wallet may display the various products that are supposed to be in the container, together with the corresponding price and description of each product. It is emphasized that the user interface indicates the virtual products that are in the virtual container, not physical products in the actual physical container. The consumer may verify whether the virtual products that are in the virtual container tally with the physical products in the actual physical container. In the affirmative, the consumer may provide a payment approval grant as described below.

After populating the virtual container with the virtual products (at step 110), the method 100 may further include generating, using the server module, a payment approval request. The payment approval request is transmitted from the server module to the consumer's mobile device. Upon receipt of the payment approval request from the server module, the mobile device may generate a message seeking the consumer's approval for the mobile payment. The mobile device may generate a payment approval grant upon receiving the consumer's approval for the mobile payment (i.e., the items that are displayed on the user interface of the digital wallet are correct and the consumer wishes to pay for his products). The payment approval grant is transmitted from the mobile device to the server module such that the mobile payment of the products can be completed. In particular, the method 100 may further comprise receiving, from the mobile device, the payment approval grant that is generated by the mobile device in response to approval of the mobile payment such that the mobile payment of the products can be completed upon receipt of the payment approval grant. On the other hand, if the items are incorrect or the consumer does not wish to pay for the products, the consumer may decline the payment approval request. In such a case, a payment decline signal may be generated by the mobile device and transmitted to the server module and the mobile payment for products is aborted.

In an implementation, in order to provide the consumer with a personalized shopping experience, the method 100 may include the following three steps. The first step involves receiving, from the mobile device, credentials stored in the digital wallet. The credentials may include data, such as consumer product purchase preferences. The second step involves generating, using the server module, personalization data based on the received credentials. The personalization data relates to the consumer product purchase preferences. The third step involves transmitting the personalization data to a broadcast module in communication with the server module. The broadcast module is configured to provide product purchase information based on the personalization data.

For example, the consumer product purchase preferences may be that a particular consumer (identified through his unique wallet identifier) frequently purchases cereal of a certain brand and type when grocery shopping at a supermarket. The generated personalization data is related to the brand and type of cereal that is frequently purchased by the particular consumer. The broadcast module, which may be a display screen disposed on a supermarket trolley, may display product purchase information (such as advertisements, relevant offers, discounts, etc.) related to the brand and type of cereal that is frequently purchased by the particular consumer. The display screen may also be able to provide directions to a shelf in the supermarket that has the preferred brand and type of cereal. The broadcast module may also be a beacon in a merchant's premises that guides the consumer to a shelf in the supermarket that has the preferred brand and type of cereal.

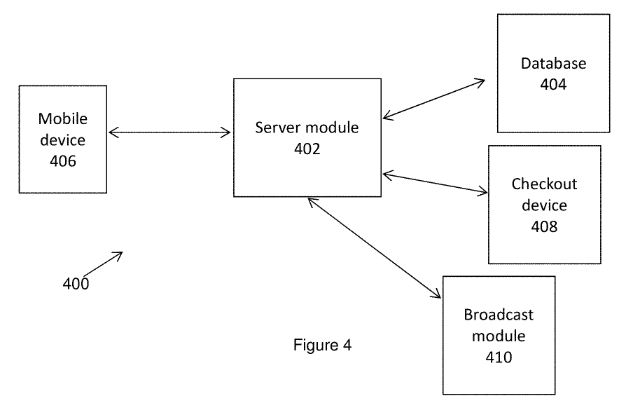

FIG. 4 shows a schematic diagram of a system 400 for facilitating mobile payment for products, according to an example embodiment. The system 400 includes a server module 402 and a database 404 in communication with the server module 402. The database 404 can be realized using cloud computing storage modules and/or dedicated computer servers.

The server module 402 is in communication with a mobile device 406 and a checkout device 408 (such as the one shown in FIG. 3) through suitable communication protocols/standards. It will be appreciated that a plurality of mobile devices and checkout devices can be coupled with the server module 402. However, for the sake of brevity, only one mobile device 406 and one checkout device 408 is described herein. The server module 402 is configured to receive, from the mobile device 406, a first container identifier encoded on a first container tag attached to a physical container (e.g., a supermarket trolley as shown in FIG. 2) for holding the products. The first container tag may comprise a near field communication (NFC) tag, a bar-code, a Quick Response (QR) Code, and/or a Bluetooth® Low Energy (BLE) tag.

The server module 402 is also configured to receive, from the mobile device 406, a wallet identifier corresponding to a digital wallet installed on the mobile device 406.

The mobile device 406 is capable of retrieving the first container identifier encoded on the first container tag attached to the physical container (e.g., using a suitable reader such as a NFC reader, bar-code reader, QR code reader or BLE receiver module) and transmitting the retrieved first container identifier and the wallet identifier to the server module 402.

The server module 402 is further configured to link a virtual container associated with the received first container identifier to the digital wallet through the received wallet identifier. The server module 402 may be configured to generate, create or provide the virtual container associated with the first container identifier upon receipt of the first container identifier from the mobile device 406. The virtual container acts as a proxy for the actual physical container in order to facilitate mobile payment using the digital wallet. The virtual container may be seen as a repository of products that a consumer wishes to purchase.

The server module 402 is further configured to receive, from the checkout device 408: (i) a product identifier encoded on a product tag attached to each of the products held in the physical container and (ii) a second container identifier encoded on a second container tag attached to the physical container.

The second container tag and/or the product tag may comprise a radio frequency identification (RFID) tag and the checkout device may comprise a RFID scanner. The checkout device 408 is capable of retrieving the product identifier encoded on the product tag attached to each of the products and the second container identifier encoded on the second container tag, and transmitting the product identifiers and the second container identifier to the server module 402.

The server module 402 may be configured to determine whether the first container identifier is identical to the second container identifier. If the first and the second container identifiers are identical, this implies that the physical container which is being presented at the checkout device is the same physical container that was used to provide a link between its corresponding virtual container and the consumer's digital wallet. On a condition that the first and the second container identifiers are identical, the server module 402 is further configured to populate the virtual container with virtual products corresponding to each of the product identifiers received from the checkout device 408 such that the mobile payment of the products can be made using the digital wallet that is linked to the virtual container. The virtual product is a proxy for the actual product and may be seen as an entry in the repository (i.e., the virtual container).

In an implementation, the server module 402 may be further configured to: generate a payment approval request after populating the virtual container with the virtual products; transmit the payment approval request to the mobile device 406; and receive, from the mobile device 406, a payment approval grant that is generated by the mobile device 406 in response to approval of the mobile payment. Mobile payment of the products can be completed upon receipt of the payment approval grant by the server module 402.

In another implementation, the server module 402 may be further configured to generate a link success notification after linking the virtual container to the digital wallet and transmit the link success notification to the mobile device 406 so that the consumer is notified that his digital wallet has been successfully linked to the virtual container.

In another implementation, in order to provide the consumer with a personalized shopping experience, the server module 402 may be further configured to receive, from the mobile device 406, credentials stored in the digital wallet. The credentials may comprise consumer product purchase preferences. The server module 402 may generate personalization data based on the received credentials. The personalization data relates to the consumer product purchase preferences. The server module 402 may transmit the personalization data to a broadcast module 410 in communication with the server module 402. The broadcast module 410 can provide product purchase information based on the personalization data. The broadcast module 410 may be a display screen disposed on a supermarket trolley, and capable of displaying product purchase information (such as advertisements, relevant offers, discounts, etc.) related to products that are frequently purchased by the particular consumer or are expected to appeal to the consumer based on his previous spending behaviour. The display screen may also be able to provide directions to a shelf in the supermarket that has a consumer's preferred brand and type of products. The broadcast module 410 may also be a beacon in the merchant's premises that guides the consumer to a shelf in the supermarket that has the preferred brand and type of products.

The product identifiers in association with their respective product data are enrolled in the database 404. The product data of each product comprises, at least, a price and/or a description of the product. After populating the virtual container with virtual products corresponding to each of the product identifiers received from the checkout device, the server module 402 can retrieve, from the database 404, the respective product data of each virtual product in the virtual container and update the digital wallet with the respective product data of each virtual product in the virtual container retrieved from the database 404 to facilitate mobile payment of the products.

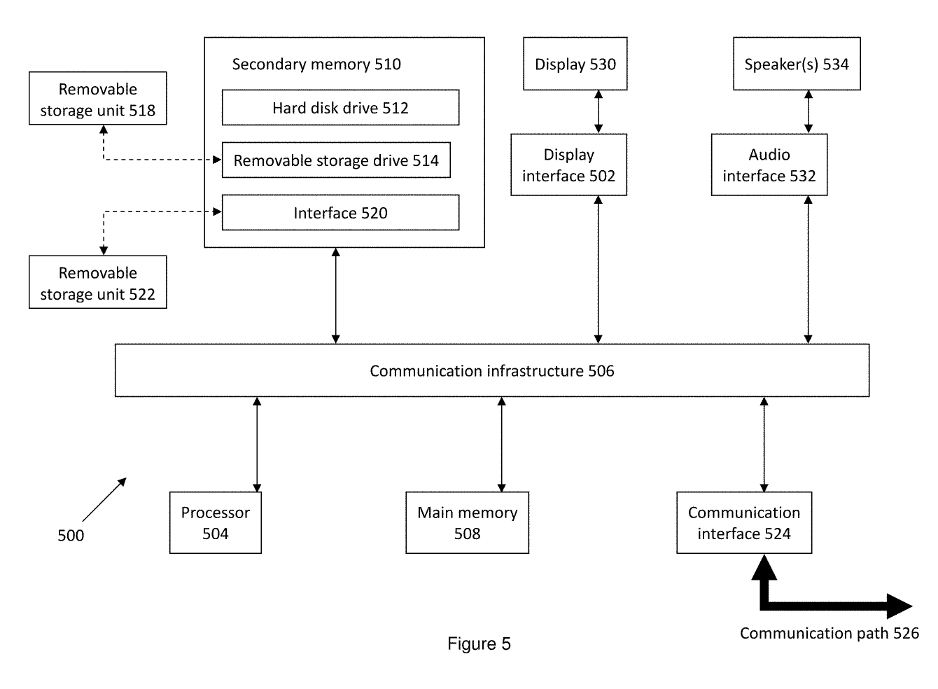

FIG. 5 shows a schematic diagram of a computer device/system 500 suitable for use realizing the server module 202. The following description of the computing device 500 is provided by way of example only and is not intended to be limiting.

As shown in FIG. 5, the example computing device 500 includes a processor 504 for executing software routines. Although a single processor is shown for the sake of clarity, the computing device 500 may also include a multi-processor system. The processor 504 is connected to a communication infrastructure 506 for communication with other components of the computing device 500. The communication infrastructure 506 may include, for example, a communications bus, cross-bar, or network.

The computing device 500 further includes a main memory 508, such as a random access memory (RAM), and a secondary memory 510. The secondary memory 510 may include, for example, a hard disk drive 512 and/or a removable storage drive 514, which may include a magnetic tape drive, an optical disk drive, or the like. The removable storage drive 514 reads from and/or writes to a removable storage unit 518 in a well-known manner. The removable storage unit 518 may include a magnetic tape, optical disk, or the like, which is read by and written to by removable storage drive 514. As will be appreciated by persons skilled in the relevant art(s), the removable storage unit 518 includes a computer readable storage medium having stored therein computer executable program code instructions and/or data.

In an alternative implementation, the secondary memory 510 may additionally or alternatively include other similar means for allowing computer programs or other instructions to be loaded into the computing device 500. Such means can include, for example, a removable storage unit 522 and an interface 520. Examples of a removable storage unit 522 and interface 520 include a program cartridge and cartridge interface (such as that found in video game console devices), a removable memory chip (such as an EPROM or PROM) and associated socket, and other removable storage units 522 and interfaces 520 which allow software and data to be transferred from the removable storage unit 522 to the computer system 500.

The computing device 500 also includes at least one communication interface 524. The communication interface 524 allows software and data to be transferred between computing device 500 and external devices via a communication path 526. In various embodiments, the communication interface 524 permits data to be transferred between the computing device 500 and a data communication network, such as a public data or private data communication network. The communication interface 524 may be used to exchange data between different computing devices 500 which such computing devices 500 form part an interconnected computer network. Examples of a communication interface 524 can include a modem, a network interface (such as an Ethernet card), a communication port, an antenna with associated circuitry and the like. The communication interface 524 may be wired or may be wireless. Software and data transferred via the communication interface 524 are in the form of signals which can be electronic, electromagnetic, optical or other signals capable of being received by the communication interface 524. These signals are provided to the communication interface via the communication path 526.

As shown in FIG. 5, the computing device 500 further includes a display interface 502 which performs operations for rendering images to an associated display 530 and an audio interface 532 for performing operations for playing audio content via associated speaker(s) 534.

As used herein, the term “computer program product” may refer, in part, to removable storage unit 518, removable storage unit 522, a hard disk installed in hard disk drive 512, or a carrier wave carrying software over communication path 526 (wireless link or cable) to the communication interface 524. Computer readable storage media refers to any non-transitory tangible storage medium that provides recorded instructions and/or data to the computing device 500 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computing device 500. Examples of transitory or non-tangible computer readable transmission media that may also participate in the provision of software, application programs, instructions and/or data to the computing device 500 include radio or infra-red transmission channels as well as a network connection to another computer or networked device, and the Internet or Intranets including e-mail transmissions and information recorded on Websites and the like.

The computer programs (also called computer program code) are stored in main memory 508 and/or secondary memory 510. Computer programs can also be received via the communication interface 524. Such computer programs, when executed, enable the computing device 500 to perform one or more features of embodiments discussed herein. In various embodiments, the computer programs, when executed, enable the processor 504 to perform features of the above-described embodiments. Accordingly, such computer programs represent controllers of the computer system 500.

Software may be stored in a computer program product and loaded into the computing device 500 using the removable storage drive 514, the hard disk drive 512, or the interface 520. Alternatively, the computer program product may be downloaded to the computer system 500 over the communications path 526. The software, when executed by the processor 504, causes the computing device 500 to perform functions of embodiments described herein.

It is to be understood that the embodiment of FIG. 5 is presented merely by way of example. Therefore, in some embodiments one or more features of the computing device 500 may be omitted. Also, in some embodiments, one or more features of the computing device 500 may be combined together. Additionally, in some embodiments, one or more features of the computing device 500 may be split into one or more component parts.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

With that said, and as described, it should be appreciated that one or more aspects of the present disclosure transform a general-purpose computing device into a special-purpose computing device when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for facilitating mobile payment for products, comprising:
receiving, from a mobile device, a first container identifier encoded on a first container tag attached to a physical container for holding the products;
receiving, from the mobile device, a wallet identifier corresponding to a digital wallet installed on the mobile device;
linking, using a server module in communication with the mobile device, a virtual container associated with the received first container identifier to the digital wallet through the received wallet identifier;
receiving, from a checkout device in communication with the server module, (i) a product identifier encoded on a product tag attached to each of the products held in the physical container and (ii) a second container identifier encoded on a second container tag attached to the physical container and, on a condition that the first and the second container identifiers are identical; and
populating, using the server module, the virtual container with virtual products corresponding to each of the product identifiers received from the checkout device such that the mobile payment of the products can be made using the digital wallet that is linked to the virtual container.

2. The method as claimed in claim 1, further comprising:
generating, using the server module, a payment approval request after populating the virtual container with the virtual products; and
transmitting the payment approval request from the server module to the mobile device.

3. The method as claimed in claim 2, further comprising:
receiving, from the mobile device, a payment approval grant that is generated by the mobile device in response to approval of the mobile payment, wherein the mobile payment of the products can be completed upon receipt of the payment approval grant.

4. The method as claimed in claim 1, further comprising:
receiving, from the mobile device, credentials stored in the digital wallet, the credentials comprising consumer product purchase preferences;
generating, using the server module, personalization data based on the received credentials, the personalization data relating to the consumer product purchase preferences; and
transmitting the personalization data to a broadcast module in communication with the server module, the broadcast module configured to provide product purchase information based on the personalization data.

5. The method as claimed in claim 1, further comprising:
generating, using the server module, a link success notification after linking the virtual container to the digital wallet; and
transmitting the link success notification from the server module to the mobile device.

6. The method as claimed in claim 1, wherein the first container tag comprises:
a near field communication (NFC) tag;
a bar-code;
a Quick Response (QR) Code; or
a Bluetooth® Low Energy (BLE) tag.

7. The method as claimed in claim 1, wherein the second container tag and/or the product tag comprises a radio frequency identification (RFID) tag.

8. The method as claimed in claim 1, further comprising:
providing, using the server module, the virtual container associated with the first container identifier upon receipt of the first container identifier from the mobile device.

9. The method as claimed in claim 1, further comprising:
enrolling, in a database in communication with the server module, the product identifiers in association with their respective product data, wherein the product data of each product comprises a price and a description of the product.

10. The method as claimed in claim 9, wherein after populating the virtual container with virtual products corresponding to each of the product identifiers received from the checkout device, the method further comprises:
retrieving, from the database, the respective product data of each virtual product in the virtual container; and
updating the digital wallet with the respective product data of each virtual product in the virtual container retrieved from the database.

11. A system for facilitating mobile payment for products, comprising:
a server module in communication with a mobile device and a checkout device, wherein the server module is configured to:
receive, from the mobile device, a first container identifier encoded on a first container tag attached to a physical container for holding the products;
receive, from the mobile device, a wallet identifier corresponding to a digital wallet installed on the mobile device;
link a virtual container associated with the received first container identifier to the digital wallet through the received wallet identifier;
receive, from the checkout device: (i) a product identifier encoded on a product tag attached to each of the products held in the physical container and (ii) a second container identifier encoded on a second container tag attached to the physical container and, on a condition that the first and the second container identifiers are identical; and
populate the virtual container with virtual products corresponding to each of the product identifiers received from the checkout device such that the mobile payment of the products can be made using the digital wallet that is linked to the virtual container.

12. The system as claimed in claim 11, wherein the server module is further configured to:
generate a payment approval request after populating the virtual container with the virtual products;
transmit the payment approval request to the mobile device; and
receive, from the mobile device, a payment approval grant that is generated by the mobile device in response to approval of the mobile payment, wherein the mobile payment of the products can be completed upon receipt of the payment approval grant.

13. The system as claimed in claim 11, wherein the server module is further configured to:
receive, from the mobile device, credentials stored in the digital wallet, the credentials comprising consumer product purchase preferences;
generate personalization data based on the received credentials, the personalization data relating to the consumer product purchase preferences; and
transmit the personalization data to a broadcast module in communication with the server module, the broadcast module configured to provide product purchase information based on the personalization data.

14. The system as claimed in claim 11, wherein the server module is further configured to:
generate a link success notification after linking the virtual container to the digital wallet; and
transmit the link success notification to the mobile device.

15. The system as claimed in claim 11, wherein the first container tag comprises:
a near field communication (NFC) tag;
a bar-code;
a Quick Response (QR) Code; or
a Bluetooth® Low Energy (BLE) tag.

16. The system as claimed in claim 11, wherein the second container tag and/or the product tag comprises a radio frequency identification (RFID) tag.

17. The system as claimed in claim 11, wherein the server module is further configured to provide the virtual container associated with the first container identifier upon receipt of the first container identifier from the mobile device.

18. The system as claimed in claim 11, further comprising a database in communication with the server module, wherein the product identifiers in association with their respective product data are enrolled in the database, and wherein the product data of each product comprises a price and a description of the product.

19. The system as claimed in claim 18, wherein after populating the virtual container with virtual products corresponding to each of the product identifiers received from the checkout device, the server module is further configured to:
retrieve, from the database, the respective product data of each virtual product in the virtual container; and
update the digital wallet with the respective product data of each virtual product in the virtual container retrieved from the database.
